(19) United States
(12) Patent Application Publication
(10) Pub. No.: US 2006/0239599 A1
(43) Pub. Date: Oct. 26, 2006

(54) Seal for an antifriction bearing

(76) Inventors: Rainer Schenk, Furth (DE); Bernard Nicola, Reichshoffen (FR); Thomas Fickert, Feuchtwangen (DE); Wolfram Kruhoeffer, Aurachtal (DE); Harald Peschke, Veitsbronn (DE)

Correspondence Address: HEDMAN & COSTIGAN P.C., 1185 AVENUE OF THE AMERICAS, NEW YORK, NY, 10036, US

(21) Appl. No.: 10/566,200

(22) PCT Filed: Jul. 20, 2004
(86) PCT No.: PCT/EP04/08067

§ 371 Date: Jan. 27, 2006

(30) Foreign Application Priority Data
Aug. 8, 2003 (DE) 103 36 341.6

(51) Int. Cl. F16C 33/76

(52) U.S. Cl. 384/484

(57) ABSTRACT

The invention relates to a sealing arrangement (1) for a rolling-contact bearing (2), comprising a rotating sealing disk (3), which engages with a sealing lip (14) in a recess (16) of the inner bearing ring (5). The sealing lip (14) is also provided with a bead (24), the arrangement and fitted position of which bring about a prestressing of the sealing lip (14) on the wall (18) of the recess (16).

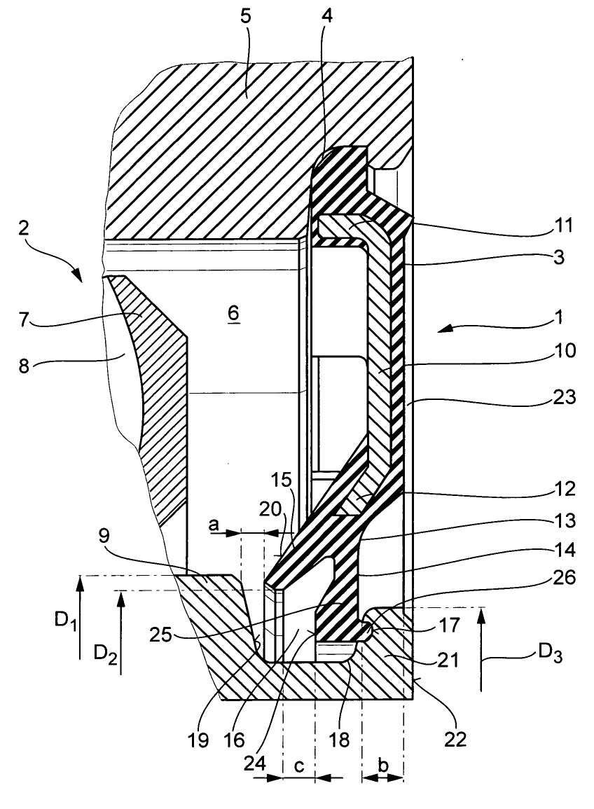

### FIELD OF THE INVENTION

The present invention relates to the sealing arrangement for a rolling-contact bearing, comprising an elastic sealing disk running around with an outer bearing ring or a housing. The sealing disk, which at least in certain regions has a reinforcement, is inserted with positive engagement in a receptacle of the outer bearing ring and on the inside forms a flexible sealing lip, which engages in a recess in the inner bearing ring. For this purpose, the sealing lip is provided with a sealing edge, which in the fitted state is supported axially on a wall of the recess.

A sealing concept of this type is known for example from the patent DE 18 01 894 C3, which represents sealing disks with different sealing lip arrangements. Common to all the exemplary embodiments is a sealing disk which is supported with a first sealing lip axially on the inner wall of the recess. A further sealing lip is assigned to a cylindrical portion of the inner bearing ring disposed axially in front of the recess, while maintaining an annular gap, i.e. with play. This sealing construction allows the ingress of contaminants when the rolling-contact bearing is at a standstill, into the recess in the inner bearing ring via the sealing lip disposed with play in front of it. In the operating state of the rolling-contact bearing there is the risk of the contaminants becoming deposited in the sealing zone between the sealing edge of the inner sealing lip and thereby overcoming the sealing zone and entering the interior of the rolling-contact bearing. The design of the known sealing arrangement also has the disadvantage that, as the rotational speed increases, the wiping inner sealing lip is supported axially on the wall of the recess with an increased pressing force. This disadvantageously increases the friction between the sealing lip and the bearing ring, accompanied by increased heating-up of the rolling-contact bearing. High bearing temperatures lead to a loss of lubricant, which directly affects the service life of the rolling-contact bearing.

### SUMMARY OF THE INVENTION

Taking into consideration the disadvantages of the known solution, the invention is based on the problem of providing a sealing arrangement for a rolling-contact bearing with which a speed-dependent prestressing of sealing lips can be achieved.

The sealing arrangement according to the invention comprises two sealing lips. In this arrangement, a first outer sealing lip is supported with nonpositive engagement on the outwardly directed wall of the recess. A second sealing lip, also referred to as a toe wall, is assigned to the inner wall of the recess with play, i.e. while maintaining a sealing gap. The construction of the sealing arrangement according to the invention also provides that an axial offset between the end face of the sealing disk and the sealing edge of the first sealing lip is obtained in the fitted position of the two seals.

To solve the stated problem, the invention provides a sealing arrangement in which the outer sealing lip bears against the outer wall of the recess in a wiping manner, and consequently with nonpositive engagement. This concept of the sealing arrangement according to the invention effectively avoids the ingress of contaminants into the recess, and consequently into the interior of the rolling-contact bearing. Furthermore, the structural design of the sealing lip makes it possible for the outer lip to be supported on the wall of the recess in a prestressed manner, controlled by the centrifugal force. This operating mode can be achieved by the sealing disk, which rotates together with the outer bearing ring of the rolling-contact bearing, being displaced as the rotational speed increases in such a way that a desired reduced contact pressure is obtained between the sealing edge of the sealing disk and the wall of the recess. In an advantageous way, the frictional loss is thereby reduced, avoiding disadvantageous heating-up of the bearing, involving loss of lubricant, which leads to premature failure of the rolling-contact bearing and reduces the service life of the rolling-contact bearing.

The operating mode according to the invention, which ensures a desired prestressing of sealing lips that is controlled by the centrifugal force, is achieved by an axial offset between the end face of the sealing disk and the sealing edge of the first sealing lip. According to the invention, the sealing lips of the sealing arrangement are arranged in the fitted position in such a way that a radial supporting line determined by the sealing disk is obtained, providing a center of mass that is axially offset from the supporting line for the first seal. The centrifugal force acting at the center of mass initiates a force component acting in the clockwise direction. This operating mode is conducive to the desired reduced contact pressure with increasing speed between the sealing edge of the sealing lip and the wall of the recess. As a supporting measure, the second sealing lip is obliquely inclined, extending from the reinforcement of the sealing disk, in relation to the inner wall of the recess. This concept is conducive in the operating state, with the sealing disk rotating, to continuous transportation of the lubricant impinging on the inner side of the second sealing lip on further to the rotating outer ring of the rolling-contact bearing.

By appropriate alignment and dimensioning of the sealing lips, a speed range for the rolling-contact bearing in which there is no or extremely small contact pressure can be empirically defined. For example, the sealing lip may be designed in such a way that, for a speed level greater than 10,000 revolutions/minute, the sealing lip is assigned to the recess wall with virtually no contact, and consequently no disadvantageous heating-up of the rolling-contact bearing originates from the seal.

Advantageous refinements of the invention are the subject of the dependent claims 1 to 14.

An advantageous refinement of the invention provides matching of a shoulder diameter of the inner bearing ring with an inside diameter of the second sealing lip. The inside diameter of the second sealing lip, designed as a toe wall, is advantageously less than the shoulder diameter of the inner bearing ring. This structural design principle has the effect that lubricant displaced axially between the rolling body and the inner ring of the rolling-contact bearing is channeled out of the rolling contact directly from the outer contour or the shoulder of the inner ring to the inner side of the second sealing lip. This produces a desired circulation of the lubricant from the inner ring to the outer ring. From the outer ring, the lubricant is taken up once again by the rolling bodies, whereby a desired, optimum circulation of the lubricant in the rolling-contact bearing is obtained.

The second sealing lip is designed in such a way that, even with a maximum rotational speed of the rolling-contact bearing, an axial distance “a” greater than 0 is obtained between the inner wall of the recess and the free end of the second sealing lip. This avoids disadvantageous sealing lip contact between the second sealing lip and the inner bearing ring.

To support the prestressing of the sealing lips that is controlled by the centrifugal force, the reinforcement integrated in the sealing disk is provided at the end directed toward the inner bearing ring with an angled-away portion, a leg, which is inclined obliquely in the direction of the recess. The adjoining sealing lips, extending from the common sealing lip root, are conducive to an axial offset in relation to the supporting line determined by the sealing disk. This concept intensifies the effect when the centrifugal force commences that the supporting force with which the first sealing lip bears against the wall of the inner bearing ring decreases with increasing speed.

Furthermore, the invention provides that the sealing edge of the first, outer sealing lip is offset axially inward with respect to the end face of the sealing disk in the fitted position of the sealing arrangement. This design on the one hand makes axial support of the sealing lip on the outer wall of the recess possible. On the other hand, this offset is conducive to the desired speed-dependently decreasing prestressing with which the sealing lip bears against the recess wall.

The sealing arrangement according to the invention also provides a defined axial offset between the two sealing lips in the fitted position. The offset is dimensioned in such a way that on the one hand a different centrifugal-force-induced displacement of the sealing lips in relation to each other is obtained, while at the same time the sealing lips are not disadvantageously influenced. A different displacement of the sealing lips may be realized for example by means of wall thicknesses of the sealing lips that differ from each other.

To achieve an increased mass of the outer sealing lip, it is provided on the outside, on the side facing the second sealing lip, with a bead. In the fitted position of the sealing arrangement, the bead supports the centrifugal-force-induced effect by which the supporting force of the outer sealing lip can be reduced with increasing speed.

A further design feature of the sealing arrangement according to the invention envisages making the wall of the recess have different heights. A preferred concept envisages designing the height of the inner recess wall, determined by the shoulder height of the inner bearing ring, in such a way that it exceeds both the inside diameter of the second sealing lip and the diameter of a portion of the inner sealing ring that is obtained between the recess and the end face of the inner bearing ring. Such a construction makes simple, nondestructive fitting possible for the sealing arrangement, in particular the inner sealing lip, since the latter does not come into contact with the inner bearing ring when the sealing arrangement is axially fed into the rolling-contact bearing. The difference in height between the recess walls is chosen in such a way that the flexible outer sealing lip can also be inserted nondestructively into the recess, for example with the aid of a tool.

A further advantageous refinement of the outer sealing lip relates to the design of the sealing edge. To avoid a state of excess pressure, or to equalize pressure differences between the interior space and the outer surroundings of the rolling-contact bearing, a venting groove is provided in the region of the sealing edge. The dimensioning of the venting groove, which is introduced into the sealing lip in a radial or inclined manner in the region of the sealing edge, on the one hand avoids the disadvantageous ingress of liquid or contaminants into the interior space of the rolling-contact bearing and at the same time avoids egress of lubricant from the rolling-contact bearing. Depending on requirements, the invention also includes the arrangement of a number of possibly smaller venting grooves arranged in a circumferentially distributed manner.

The sealing arrangement according to the invention can be used for example for a rolling-contact bearing which is provided in a tension roller or a deflecting roller of a belt, chain or similar drive. To optimize the components, it is appropriate to assign the sealing arrangement according to the invention directly to a running disk of the tension roller of the deflecting roller. For this purpose, the sealing disk is connected in a rotationally fixed manner to the running disk, which is supported on a belt or the like and at the same time undertakes the function of the outer rotating bearing ring of the rolling-contact bearing.

The invention can also be transferred to a rolling-contact bearing of a tension roller or a deflecting roller in which a locating pin or carrying body at the same time performs the function of the inner bearing ring. The locating pin or carrying body, which is rotationally fixed in the fitted state, is provided for this purpose with a recess for receiving the sealing lips of the sealing arrangement according to the invention.

Adequate strength or rigidity of the sealing arrangement is achieved by means of a reinforcement, which is formed to the greatest extent in a disk-like manner and extends over a large portion of the annular distance between the inner bearing ring and the outer bearing ring of the rolling-contact bearing. According to the invention, the reinforcement, which is encapsulated at least on the outside by the sealing material of the sealing arrangement, forms on the outside a right-angled flanging in the region of the fastening provided on the outer bearing ring. At the inner circumference, directed toward the sealing lips, the reinforcement is provided with a leg which is directed obliquely in the direction of the recess, is encapsulated on all sides by the sealing material and is directly adjoined by the sealing lip root.

### BRIEF DESCRIPTION OF THE DRAWING

The invention is represented on the basis of a figure, in which the sealing arrangement according to the invention can be seen in the fitted state.

### DETAILED DESCRIPTION OF THE DRAWING

In the only figure, the construction of a sealing arrangement 1 according to the invention for a rolling-contact bearing 2 is represented in the fitted state. The sealing arrangement 1 comprises a sealing disk 3, which is positionally fixed on an outer circumference in a positively engaging and elastic manner in an annular groove 4 of an outer peripheral bearing ring 5. The sealing disk 3, running around with the bearing ring 5, encloses an annular fitting space 6 of the rolling-contact bearing 2, in which there are rolling bodies 8, which are kept in a rolling body cage 7 and guided in raceways of the outer bearing ring 5 and an inner bearing ring 9. To stiffen it, the sealing disk 3, which is produced from an elastic sealing material, is provided with a reinforcement 10, which is shaped in the manner of a disk. In the direction of the outer bearing ring 5, the reinforcement 10 forms a right-angled flange 11. In the direction of the inner bearing ring 9, the reinforcement 10 is adjoined by an inwardly inclined leg 12.

In the same way, the flange 11 and the leg 12 are completely encapsulated by the sealing material of the sealing disk 3. The free end of the leg 12 is adjoined by the sealing lip root 13, formed from the sealing material. The sealing lip root 13 forms the basis for two sealing lips 14, 15, which are assigned to a recess 16 made in the inner bearing ring 9. The sealing lip 14 is supported by means of a sealing edge 17 on a virtually radially aligned outer wall 18 of the recess 16. The further sealing lip 15 is aligned in the direction of the inner wall 19 of the recess 16 as an extension of the leg 12 of the reinforcement 10. In the fitted state, the free end of the sealing lip 15 is taken to within a distance “a” from the inner wall 19.

Further design features of the inner bearing ring 9 in connection with the sealing lips 14, 15 relate to diameter ratios and to axial distances. A shoulder diameter “D₁” of the inner bearing ring 9 dimensionally exceeds the inside diameter “D₂” of the inner sealing lip 15, formed as a toe wall. This structural design ensures that lubricant displaced from the rolling contact between the rolling body 8 and the inner bearing ring 9 is channeled axially from the bearing ring 9 to an inner side 20 of the sealing lip 15. From the rotating sealing disk 3 and the sealing lip 15 in connection with it, the lubricant is transported by centrifugal force to the inner side of the outer bearing ring 5, before it returns to the rolling bodies 8.

The walls 18, 19, which axially delimit the recess 16, have different wall heights. The size of the inner wall 19 determines the shoulder diameter “D₁”, this diameter exceeding the diameter of a radially stepped portion 21, which is obtained between the recess 16 and an end face 22 of the inner bearing ring 9. In the fitted state, the sealing edge 17 is axially offset, characterized by the dimension “b”, which is obtained between the end face 23 of the sealing disk 3 and the contact surface of the sealing edge 17 on the outer wall 18. The sealing lips 14, 15, arranged such that they are spread in relation to each other, form a distance “c”, which is chosen in such a way that on the one hand unhindered, nondestructive fitting of the sealing disk 3 is ensured and on the other hand the sealing lips 14, 15 do not hinder each other in the fitted state. The sealing lip 14 has on the outside, on the side facing away from the sealing edge 17, a bead 24, with which an increased mass of the sealing lip 14 can be deliberately achieved in the outer region. The bead 24 increases the mass of the sealing lip 14 in the outer zone. This produces a center of mass 25, which is arranged axially offset in relation to a radial supporting line formed by the sealing disk 3. With increasing speed of the rolling-contact bearing, i.e. rotating outer bearing ring 5 in connection with the sealing disk 3 and the associated sealing lips 14, 15, the centrifugal force acting at the center of mass 25 initiates a force component acting according to the direction of the arrow, in the clockwise direction. This results in a speed-dependent prestressing of the sealing lip 14 that is controlled by the centrifugal force, with which the supporting force of the sealing lip 14 in the region of the sealing edge 17 decreases synchronously with the increase in speed. The sealing lip 14 also has in the region of the sealing edge 17 a venting groove 26, which ensures an effective pressure equalization between the fitting space 6 and the outer surroundings of the atmosphere of the rolling-contact bearing 2.

### DESIGNATIONS

1 sealing arrangement
2 rolling-contact bearing
3 sealing disk
4 annular groove
5 bearing ring (outer)
6 fitting space
7 rolling-contact bearing cage
8 rolling body
9 bearing ring (inner)
10 reinforcement
11 flange
12 leg
13 sealing lip root
14 sealing lip
15 sealing lip
16 recess
17 sealing edge
18 wall
19 wall
20 inner side
21 portion
22 end face
23 end face
24 bead
25 center of mass
26 venting groove
a distance (between sealing lip 15 and wall 19)
b axial offset (between the end face 23 of the sealing disk 3 and the sealing edge 17)
c distance (between the sealing lips 14, 15)
D₁ shoulder diameter (inner bearing ring 9)
D₂ inside diameter (sealing lip 15)
D₃ diameter of portion 21 (between recess 16 and end face 22 of the bearing ring 9)

1. A sealing arrangement for a rolling-contact bearing (2), comprising an elastic sealing disk (3) running around with an outer bearing ring (5) or a housing, having a reinforcement (10) and positionally fixed with positive engagement in a receptacle or an annular groove (4), the sealing disk (3) engaging with a flexible seal in a recess (16) of an inner bearing ring (9) and being supported by means of a sealing edge (17) on a wall (18), characterized in that the first sealing lip (14) is supported axially on the outer wall (18) of the recess (16) and a second sealing lip (15) is assigned to the inner wall (9) of the recess (16) with play, a mass of the first sealing lip (14) forming a center of mass (25), which, in a fitted position of the sealing arrangement (1), is offset in relation to a supporting line determined by the sealing disk (3) in such a way that the centrifugal force acting at the center of mass (25) initiates a force component acting in the clockwise direction.

2. The sealing arrangement as claimed in claim 1, in which a shoulder diameter (D₁) of the inner bearing ring (9) exceeds an inside diameter (D₂) of the inner sealing lip (15).

3. The sealing arrangement as claimed in claim 2, in which a distance (a) between the inner wall (19) of the recess (16) and a free end of the second sealing lip (15) is designed in such a way that, even with a maximum rotational speed of the rolling-contact bearing (2), it ensures a distance (a) >0.

4. The sealing arrangement as claimed in claim 1, the first and second sealing lips (14, 15) being made to extend from a common sealing lip root (13) of the sealing disk (13).

5. The sealing arrangement as claimed in claim 1, an axial offset (b) between an end face (23) of the sealing disk (3) and the sealing edge (17) of the first sealing lip (14) being obtained in a fitted position of the two sealing lips (14, 15).

6. The sealing arrangement as claimed in claim 1, in which the second sealing lip (15), obliquely inclined in relation to the inner wall (19) and designed as a toe wall, is arranged axially offset in relation to the first sealing lip (14) by a distance (c).

7. The sealing arrangement as claimed in claim 1, the first sealing lip (14) having on the outside, on the side facing the second sealing lip (15), a bead (24).

8. The sealing arrangement as claimed in claim 1, the recess (16) of which in the inner bearing ring (9) has walls of different heights, the height of the inner wall (19), defined by the shoulder diameter (D₁) of the bearing ring (9), exceeding the size of the diameter (D₃) of the bearing ring (9) in the region between the recess (16) and the end face (22) and also the inside diameter (D₂) of the second sealing lip (15).

9. The sealing arrangement as claimed in claim 1, the first sealing lip (14) being provided with at least one venting groove (26) in the region of the sealing edge (17).

10. The sealing arrangement as claimed in claim 9, the venting groove (26) of which is made to extend in a radial or inclined manner.

11. The sealing arrangement as claimed in claim 1, which is intended for a rolling-contact bearing (2) that is used in a tensioning roller or a deflecting roller of a tensioning system by which a belt or the like of a belt, chain or similar drive is pretensioned.

12. The sealing arrangement as claimed in claim 11, the construction of the tensioning roller or deflecting roller comprising a running disk which encloses the rolling-contact bearing and at the same time undertakes the function of an outer peripheral bearing ring.

13. The sealing arrangement as claimed in claim 11, in which the tensioning roller or deflecting roller includes a rotationally fixed locating pin or carrying body for the rolling-contact bearing which at the same time includes the function of an inner, rotationally fixed bearing ring.

14. The sealing arrangement as claimed in claim 1, the reinforcement (10), formed in the manner of a disk, of the sealing disk (3) being encapsulated at least on one side by an elastic sealing material of the sealing arrangement (1) and the reinforcement (10) forming on the outside an angled-away flange (11) and on the inside a leg (12) inclined obliquely in the direction of the recess (16).
